(19) United States
(12) Patent Application Publication
(10) Pub. No.: US 2005/0198012 A1
(43) Pub. Date: Sep. 8, 2005

(54) Method for providing data for a querying communication terminal

(75) Inventors: Bernhard Bohmer, Berlin (DE); Thomas Lude, Berlin (DE); Jos Moons, Keerbergen (BE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/793,683

(22) Filed: Mar. 5, 2004

(51) Int. Cl. G06F 7/00

(52) U.S. Cl. 707/3

(57) ABSTRACT

The invention relates to a method for providing data relating to a user of a communication terminal for a querying communication terminal. The method involves a network node in a telecommunication network receiving a data query message from the querying communication terminal, the data query message being used to transmit an identifier for the querying communication terminal or for a user of the querying communication terminal. A data store is read to determine whether the received identifier is associated with a group of communication subscribers, and the existence of such an association prompts the network node to ascertain which information types are associated with this group. The data which relate to the user of the communication terminal and are connected with these information types are then provided for the querying communication terminal.

### TECHNICAL FIELD OF THE INVENTION

The invention relates to a method for providing data relating to a user of a communication terminal for a querying communication terminal.

### BACKGROUND OF THE INVENTION

Storage units in telecommunication networks often store data which relate to users of communication terminals. Particularly if these are person-related or personal data for these users, such data must not be able to be queried in uncontrolled fashion by other communication terminals or by other users.

### SUMMARY OF THE INVENTION

The invention discloses a method which can be used to provide data relating to a user of a communication terminal in a controlled manner.

In one embodiment of the invention, there is a method for providing data relating to a user of a communication terminal for a querying communication terminal, where the method involves a network node in a telecommunication network receiving a data query message from the querying communication terminal, the data query message being used to transmit an identifier for the querying communication terminal or for a user of the querying communication terminal, a data store being read to determine whether the received identifier is associated with a group of communication subscribers, the existence of such an association prompting the network node to ascertain which information types are associated with this group, and the data which relate to the user of the communication terminal and are connected with these information types then being provided for the querying communication terminal. In this case, it is particularly advantageous that the querying communication terminal is provided with such data relating to the user of the communication terminal as belong to the information types which are associated with the group. It is thus a simple matter to limit the data which can be provided using associations, stored in the data store, between identifiers and groups of communication subscribers and between groups and information types.

In one aspect of the invention, the data relating to the user of the communication terminal involves data being read from a storage unit at the network node. The data relating to the user of the communication terminal can then be transmitted from the network node in the telecommunication network to the querying communication terminal.

Advantageously, the network node used may be a presence server. Presence servers as such are already available in telecommunication networks. The inventive method can therefore be implemented particularly easily and inexpensively using such presence servers.

In another aspect of the invention, there is a provision for the data to be preceded by a check to determine whether the querying communication terminal or the user of the querying communication terminal has been entered in a prohibited list, and the data are provided if the querying communication terminal or the user of the querying communication terminal has not been entered in the prohibited list. Such a prohibited list can advantageously be used to preclude a querying communication terminal or its user from data provision in a simple manner without this requiring the associations stored in the data store to be changed or deleted.

In still another aspect of the invention, if the received identifier is not associated with a group of communication subscribers, the network node transmits a query message AN including the identifier to the communication terminal, the communication terminal then outputs an identifier for the querying communication terminal or for a user of the querying communication terminal using an output device, the communication terminal accepts an input following the identifier which has been output, the input providing the communication terminal with information about a group of communication subscribers with which the identifier can be associated, the communication terminal transmits this information to the network node, and the network node then provides the data connected with the information types. A particular advantage in this context is that the input of information about the group of information subscribers on the communication terminal allows provision of the data to be controlled.

Advantageously, the information about the group of communication subscribers with which the identifier (MSISDN) can be associated can be stored in the data store at the network node. As a result, the information which is input is available at the network node for subsequent method sequences.

The output device used may be a display unit on the communication terminal. The input may be accepted using a keypad on the communication terminal.

In yet another aspect of the invention, the input provides the communication terminal with information about a new group of communication subscribers which is to be set up with which the identifier can be associated. This variant of the inventive method allows data to be provided in controlled fashion even if there is still no group set up which is suitable (for the querying communication terminal or its user).

In this case, the information about the new group which is to be set up may also comprise the information types which can be associated with this group. This allows information types to be associated on a group-specific basis with the new group which is to be set up.

In still another aspect of the invention, the communication terminal transmits the information about the new group which is to be set up and information about the association between the identifier and the new group which is to be set up to the network node in order to store this information there.

### BRIEF DESCRIPTION OF THE DRAWINGS

To explain the invention further, the text below explains exemplary embodiments with reference to the drawings, in which:

FIG. 1 shows an exemplary embodiment of the inventive method.

FIG. 2 shows exemplary embodiments of a data query message.

FIG. 3 shows an exemplary embodiment of a data message.

FIG. 4 shows an exemplary embodiment of a data table stored in a data store.

FIG. 5 shows an exemplary embodiment of a further data table stored in a data store.

FIG. 6 shows an exemplary embodiment of a modified data table.

FIG. 7 shows a further exemplary embodiment of the invention.

FIG. 8 shows methods a further exemplary embodiment.

### DETAILED DESCRIPTION OF THE INVENTION

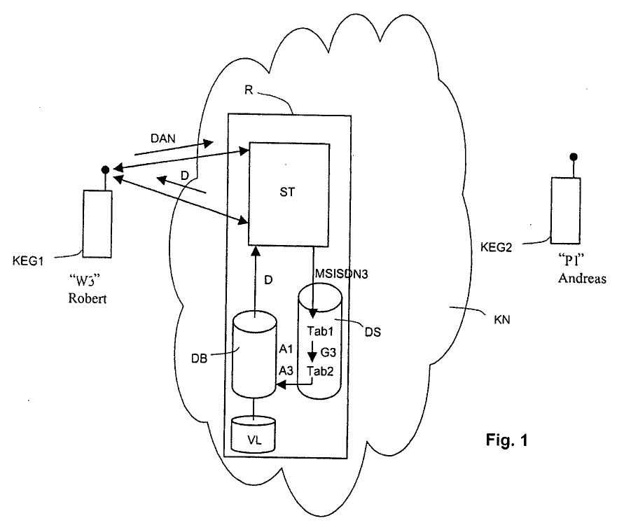

FIG. 1 schematically shows a communication network KN which, by way of example, is a second or third generation mobile radio network (e.g. a GSM or GPRS mobile radio network). Of this communication network KN, one network node R in the form of a presence server is shown. Such a presence server R and a presence service, which can be provided using this presence server, as such are known, by way of example, from the specification 3GPP TS 23.141. V6.3.0 (2003-06), 3rd General Partnership Project; Technical Specification Group Services and System Aspects; Presence Service; Architecture and Functional Description (Release 6).

FIG. 1 likewise shows a communication terminal KEG1 in the form of a mobile telephone which is used by a communication subscriber “Robert”. In addition, FIG. 1 shows a communication terminal KEG2 in the form of a second mobile telephone which is used by a communication subscriber “Andreas”. The communication terminal KEG1 is intended to be used to query data relating to the user “Andreas” of the communication terminal KEG2. For this reason, the communication terminal KEG1 is also referred to as the querying communication terminal KEG1 below.

The user “Robert” of the querying communication terminal KEG1 or the querying communication terminal KEG1 is occasionally also referred to as the “watcher”. The user “Andreas” of the communication terminal KEG2 or the communication terminal KEG2 is occasionally also referred to as the “presentity”. For this reason, the communication terminal KEG2 is denoted by “P1” (=presentity 1) and the querying communication terminal KEG1 is denoted by “W3” (=“watcher 3”) in FIG. 1. The presence server R is a network node in the telecommunication network KN connecting the communication terminal KEG2 and the querying communication terminal KEG1.

At the start of the method, the querying communication terminal KEG1 sends a data query message DAN to the network node R.

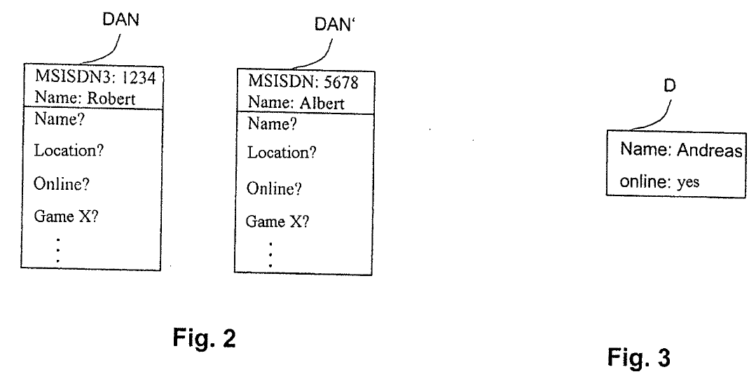

FIG. 2 shows the structure of such a data query message DAN. As an identifier (identity identifier) for the querying communication terminal KEG1, the data query message DAN contains the mobile telephone number MSISDN3 (“1234”) of the querying communication terminal KEG1 (MSISDN=Mobile Station ISDN Number). In addition, the data query message DAN (optionally) contains the name “Robert” of the user of the querying communication terminal KEG1. The data query message DAN is also used to transmit the information that the querying communication terminal KEG1 wishes to query the name of the user of the communication terminal KEG2, the current whereabouts of the communication terminal KEG2 or its user, and the online status of this communication terminal or its user. (Querying the online status is intended to be understood to mean a query to determine whether the communication terminal KEG2 has currently set up an active user data connection to the communication network KN, that is to say whether it is “online”. An active user data connection is not necessary for carrying out the method per se, since the data query message DAN and the further requisite information can be transmitted via permanently usable signaling channels.) In addition, the data query message DAN is used to query whether the user of the communication terminal KEG2 or his communication terminal KEG2 is taking part in a game “X” which can be played over the communication network KN. (The latter query can be made, by way of example, using freetext fields—“freetext attributes”.) The queried data are shown symbolically in the bottom part of the data query message DAN.

The specific values of the queried data are stored in a storage unit DB (shown in FIG. 1) in the presence server R. As FIG. 1 shows, the data query message DAN is received by the network node R. A control device ST in this presence server R reads a data store DS to determine whether the received identifier is associated with a group of communication subscribers. For this purpose, the data store DS stores a data table Tab1.

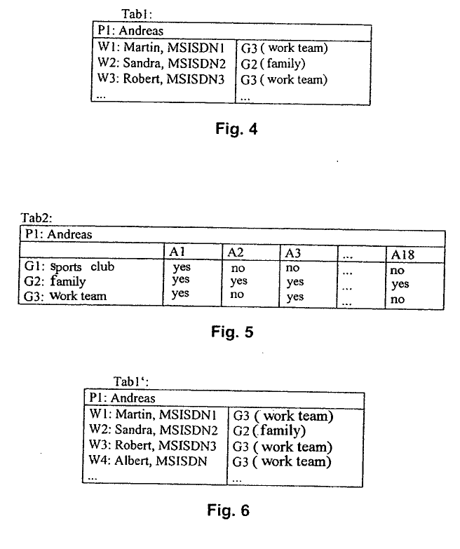

FIG. 4 shows the data table Tab1 in the data store DS. This data table Tab1 is associated with the user “Andreas” of the communication terminal KEG2. This user “Andreas” is a first “Presentity” P1 (P1=presentity 1). The data table Tab1 shows three “watchers” in the left-hand column:
first “watcher” W1: “Martin”,
second “watcher” W2: “Sandra”,
third “watcher” W3: “Robert”.

These three communication subscribers can each be clearly identified using an identifier in the form of their mobile radio telephone number MSISDN1, MSISDN2 or MSISDN3. On the right-hand side of the data table Tab1, the group of communication subscribers which is respectively associated with the identifier MSISDN1, MSISDN2 or MSISDN3 is stored. Thus, by way of example, the identifier MSISDN1 (watcher W1 “Martin”) has the associated group G3 of communication subscribers (work team). Similarly, the identifier MSISDN2 (watcher W2 “Sandra”) has the associated group G2 (family). This is because Sandra belongs to Andreas' family, and she is therefore shown as a member of the group G2 (“family”) The identifier MSISDN3 of the third watcher W3 “Robert” has the associated group G3 (work team), since Robert works with Andreas in a team. In another exemplary embodiment, it would also be possible for an identifier (a watcher) to have a plurality of associated groups.

The network node R attempts to read a table entry relating to the “watcher” W3 (Robert) from the data table Tab`. Such a table entry is held in the table (third row of the data table Tab1). From this table entry, the control device ST at the network node reads that the received identifier MSISDN3 is associated with the group G3 (work team). The next step is to ascertain which information types are associated with this group. To this end, a further data table Tab2 is used, which is likewise stored in the data store DS shown in FIG. 1.

FIG. 5 shows this further data table Tab2. The further data table Tab2 contains information about the individual groups (G1, G2 and G3) of respectively associated information types (A1, A2, A3 . . . to A18). Thus, by way of example, the first group of communication subscribers (G1: sports club) has merely the first information type A1 associated with it. The second group of communication subscribers (G2: family) has all of the information types A1 to A18 associated with it. The third group G3 (work team) has the first information type A1 and the third information type A3 associated with it.

In the exemplary embodiment, the information types A1, A2, A3 and A18 have the following significance:
Information type A1: Name (or alias name) of the user of the communication terminal (name of the presentity)
Information type A2: Current whereabouts of the communication terminal or of the user of this communication terminal (location of the presentity)
Information type A3: Online status of the communication terminal (online status of the presentity)
Information type A18: Participation in communication network game “X”.

The other information types A4 to A17 may have similar significances.

As FIG. 1 also shows, the data table Tab2 in the data store DS is read to determine which information types are associated with the group G3. In line with the data table Tab2 shown in FIG. 5, these are the information types A1 and A3 in the exemplary embodiment. This information (“A1, A3”) about the associated information types is transmitted from the data store DS to the storage unit DB in the presence server R. Subsequently, only the data relating to the user “Andreas” of the communication terminal KEG2 which are connected with these two information types A1 and A3 are provided for the querying communication terminal. This is done by reading these data from the storage unit DB in the presence server R. These data are then transmitted from the presence server R to the querying communication terminal KEG1 using a data message D.

Specifically, what is read from the storage unit DB is the data item “Name: Andreas” connected with information type A1, relating to the user “Andreas” of the communication terminal, and the data item “online: yes” connected with information type A3, relating to the user “Andreas” of the communication terminal KEG2. The further data, queried using the data query message DAN, about the location (“Location?”, information type A2) and the participation in the game X (“Game X?”, information type A18) are not read, since the group G3 merely has the associated information types A1 and A3.

The two data items read “Name: Andreas” and “online: yes” are, as shown schematically in FIG. 3, transmitted from the network node to the querying communication terminal KEG1 belonging to the watcher “Robert” using the data message D.

On the basis of the association between the identifier MSISDN3 and the group G3 of communication subscribers, two different data items (name and online status) are thus provided for the querying communication terminal KEG1. In another exemplary embodiment, it is naturally also possible to provide more than two different data items (that is to say a multiplicity of data items) on the basis of the one association.

Additionally, provision of the data can be preceded by a check by the network node R to determine whether the identifier MSISDN3 of the querying communication terminal KEG1 or of the user of the querying communication terminal KEG1 has been entered in a prohibited list VL. Such a prohibited list includes the identifiers of the querying communication terminals for which no data are to be transmitted (for example because the telephone charges have not been paid to a sufficient level in the past). Such prohibited lists are also called “black lists”. Such a prohibited list may also be set up and/or managed by the user “presentity” of the communication terminal KEG2. This means that the user of the communication terminal KEG2 may also reliably prevent the data from being provided for selected querying communication terminals. In this exemplary embodiment, the network node establishes that the identifier MSISDN3 has not been entered in the prohibited list. Only then are the data provided and transmitted to the querying communication terminal KEG1 of the watcher “Robert” using the data message D.

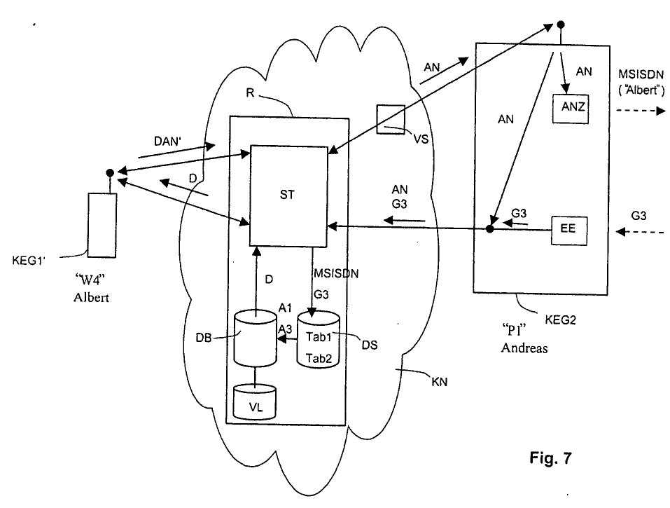

FIG. 7 shows a further exemplary embodiment of the inventive method. This further exemplary embodiment differs from the example illustrated in connection with FIG. 1 in that the querying communication terminal KEG1′ used is a mobile telephone belonging to a user “Albert”. This querying communication terminal KEG1′ or its user “Albert” has the associated mobile telephone number MSISDN (e.g. 5678). In a similar manner to the method sequence illustrated with reference to FIG. 1, a data query message DAN' (shown in FIG. 2) is sent to the network node R. As an identifier for the querying communication terminal KEG1′, this data query message DAN' contains the mobile telephone number MSISDN (“5678”) of the querying communication terminal KEG1′ and (optionally) the name “Albert” of the user of the querying communication terminal KEG1′.

The network node R now reads the data store DS to determine whether the received identifier is associated with a group of communication subscribers. However, the data table Tab1 inclues no such table entry about the “watcher” W4 (Albert) with the identifier MSISDN, that is to say that the received identifier is not associated with any group of communication subscribers. Hence, the network node sends a query message AN containing the identifier to the communication terminal KEG2 via a switching center VS (mobile switching center) in the communication network KN. The structure of the query message AN may be like that of the data query message DAN'.

The communication terminal KEG2 reads the identifier MSISDN (“5678”) from the query message AN. Next, the communication terminal KEG2 outputs an identifier for the querying communication terminal KEG1′ (or an identifier for the user of the querying communication terminal KEG1′) using an output device ANZ. In the exemplary embodiment, the output device ANZ is in the form of a display unit ANZ on the mobile telephone KEG2. The identifier may be, by way of example, the identifier (the mobile telephone number MSISDN) or the name (“Albert”) of the user of the querying communication terminal KEG1. If the name has not been transmitted using the query message AN, then the name may also be read from a telephone book store in the communication terminal KEG2 on the basis of the known mobile telephone number MSISDN.

From this identifier MSISDN, the user “Andreas” identifies that the querying communication terminal KEG1 is being used by the user “Albert”. Since the user “Albert” is a work colleague of the user “Andreas”, the identifier MSISDN can be associated with Andreas' work team G3 (which is a group of communication subscribers). Accordingly, the user “Andreas” uses an input device EE on the communication terminal KEG2 (in this exemplary embodiment uses a keypad EE on the communication terminal KEG2) to input the character string “G3” (or another name for the group G3, e.g. the character string “work team”). This input G3 is accepted by the communication terminal KEG2, which provides the communication terminal KEG2 with the information that the identifier MSISDN can be associated with the group G3 of communication subscribers (that is to say with the work team).

The communication terminal KEG2 then sends the query message AN together with the information about the association between the identifier MSISDN and the group G3 to the network node R in the communication network. The network node R reads the table Tab2 in a known manner to determine which information types are associated with the group G3. In the exemplary embodiment, these are the information types A1 and A3. The network node R then provides the data D connected with information types A1 and A3.

As FIG. 7 shows, the control device ST in the presence server R stores the information about the association between the identifier MSISDN and the group G3 of communication subscribers in the store DS at the network node R. This information is entered into the data table Tab1. This results in a fourth table entry, as shown in FIG. 6 in the modified table Tab1′. The fourth table entry includes the information that the identifier MSISDN of the user “Albert” (who is the fourth watcher W4) is associated with the group G3 of communication subscribers (work team).

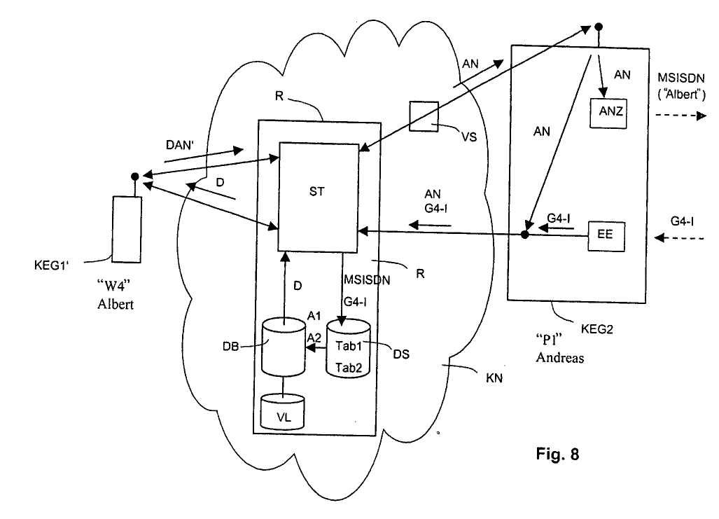

FIG. 8 shows a further exemplary embodiment of the inventive method, which differs from the method illustrated in connection with FIG. 7 in that the communication terminal KEG2 accepts a specific input via the input device EE when the identifier is output. This specific input comprises information about a new group G4 of communication subscribers which is to be set up with which the identifier MSISDN can be associated. This new group G4 of communication subscribers which is to be set up has, for the time being, just one associated communication subscriber, namely the communication subscriber “Albert”.

The information about the new group G4 which is to be set up is referred to as “G4 information” G4-I in FIG. 8. This G4 information G4-I reveals that the new group G4 which is to be set up relates to a skittles club and that this group G4 has the associated information types A1 and A2. The information G4-I about the new group G4 of communication subscribers which is to be set up thus comprises the information types Al and A2 which can be associated with this group.

The communication terminal KEG2 transmits the information about the new group which is to be set up in the form of the G4 information G4-I and also additionally the input information about the association between the identifier MSISDN and the new group G4 which is to be set up to the network node R. The information G4-I about the new group G4 which is to be set up is then stored in the second data table Tab2; the information about the association between the identifier MSISDN and the new group G4 which is to be set up is stored in the first data table Tab1. Hence, the data store DS in the presence server R has been extended by a new group G4 of communication subscribers and by a new association between an identifier and the new group G4 of communication subscribers. (The association between the identifier and the new group which is to be set up may also be referred to as classification of the identifier into the new group G4 which is to be set up.)

In the case of the method described, it is particularly advantageous that the association, stored in the data store DS, between information types and groups of communication subscribers means that a relatively small number of information items needs to be accepted by the communication terminal KEG2 during the input. If there is already a suitable group for the querying communication terminal KEG1 (which can be identified by the identifier) or for its user and this group is stored in the data table Tab2 in the data store DS, then the communication terminal KEG2 needs to accept only a single information item during the input: namely information about the one group of communication subscribers which can be associated with the identifier. In the case of the inventive method, it is thus advantageously possible to take the one association between the group of communication subscribers and the identifier as a basis for providing the data.

Should no suitable group be stored in the data store DS, then the communication terminal KEG2 needs to accept just a small number N of information items during the input, where it holds true that: N=(number of different information types+1). The reason for this is that, for the one new group which is to be set up, it is merely necessary to input for each of the information types whether this information type is associated with the new group which is to be set up (“yes” in the second data table Tab2) or is not associated therewith (“no” in the second data table Tab2). The information about the new group which is to be set up itself (e.g. “group G4”) is the information “+1”. As soon as the information about the new group of communication subscribers which is to be set up is stored in the data store, a maximum of a single input (e.g. “G4”) is required for a data query message from a member of this group which has been set up. The result is a method for providing data relating to a user of a communication terminal which is extremely simple to carry out and convenient.

Another advantage of the method described is that—provided that the received identifier is associated with a group—the network node provides the data of the respective information types for transmission to the querying communication terminal KEG1 automatically without any involvement by the communication terminal KEG2.

1. A method for providing data relating to a user of a communication terminal for a querying communication terminal, comprising:
a network node in a telecommunication network receiving a data query message from the querying communication terminal, the data query message used to transmit an identifier for the querying communication terminal or for a user of the querying communication terminal; and
a data store read to determine whether the received identifier is associated with a group of communication subscribers, wherein
the network node is prompted, if an association exists, to ascertain which information types are associated with the group, and
the data which relate to the user of the communication terminal and are connected with the information types is provided for the querying communication terminal.

2. The method as claimed in claim 1, wherein the data relating to the user of the communication terminal involves the data being read from a storage unit at the network node.

3. The method as claimed in claim 1, wherein the data relating to the user of the communication terminal are transmitted from the network node in the telecommunication network to the querying communication terminal.

4. The method as claimed in claim 1, wherein the network node used is a presence server.

5. The method as claimed in claim 1, wherein the data is preceded by a check to determine whether the querying communication terminal or the user of the querying communication terminal has been entered in a prohibited list, and
the data are provided if the querying communication terminal or the user of the querying communication terminal has not been entered in the prohibited list.

6. The method as claimed in claim 1, wherein if the received identifier is not associated with a group of communication subscribers, the network node transmits a query message including the identifier to the communication terminal,
the communication terminal then outputs an identifier for the querying communication terminal or for a user of the querying communication terminal using an output device,
the communication terminal accepts an input following the identifier which has been output, the input providing the communication terminal with information about a group of communication subscribers with which the identifier is associated,
the communication terminal transmits the information to the network node, and
the network node provides the data connected with the information types.

7. The method as claimed in claim 6, wherein the information about the group of communication subscribers with which the identifier is associated is stored in the data store at the network node.

8. The method as claimed in claim 6, wherein the output device used is a display unit on the communication terminal.

9. The method as claimed in claim 6, wherein the input is accepted using a keypad on the communication terminal.

10. The method as claimed in claim 6, wherein the input provides the communication terminal with information about a new group of communication subscribers which is to be set up with which the identifier can be associated.

11. The method as claimed in claim 10, wherein the information about the new group which is to be set up comprises the information types which can be associated with the group.

12. The method as claimed in claim 10, wherein the communication terminal transmits the information about the new group which is to be set up and information about the association between the identifier and the new group which is to be set up to the network node in order to store the information there.
